(19) United States
(12) Patent Application Publication
(10) Pub. No.: US 2024/0180083 A1
(43) Pub. Date: Jun. 6, 2024

(54) MOUNTING SYSTEMS FOR SUPPORTING DECORATIVE STRUCTURES ON OBJECTS

(71) Applicants: Sara Blumenstein, Great Neck, NY (US); Phil Cook, Queens Village, NY (US)

(72) Inventors: Sara Blumenstein, Great Neck, NY (US); Phil Cook, Queens Village, NY (US)

(21) Appl. No.: 18/486,332

(22) Filed: Oct. 13, 2023

Related U.S. Application Data
(60) Provisional application No. 63/418,845, filed on Oct. 24, 2022.

(51) Int. Cl. A01G 5/04

(52) U.S. Cl. CPC A01G 5/04

(57) ABSTRACT

A mounting system for securing a decorative structure to an object includes an assembly configured to be secured to the object and a holder coupled to the assembly. The holder defines a first slot through a first end face of the holder. The first slot is configured to receive a portion of the decorative structure to secure the decorative structure to the holder and the assembly when the assembly is coupled to the object. The first slot may have a Y-shaped configuration.

### CROSS-REFERENCE TO RELATED APPLICATIONS

This application claims the benefit of U.S. Provisional Patent Application Ser. No. 63/418,845, filed Oct. 24, 2022, the entire contents of which are incorporated by reference herein.

### FIELD

This disclosure relates to mounting systems for supporting decorative structures on objects, and, more particularly, to decorative structures and mounting systems for supporting floral or other ornamental decorative structures on objects.

### BACKGROUND

Floral and other decorative structures that can be mounted to objects such as persons, clothing, clothing accessories, and/or household objects require the use of permanent or semi-permanent attachment methods. These attachment methods include techniques such as ironing-on, sewing, gluing, pinning, and stapling. Once the decorative structure is attached, there is no easy way to change it. And, with garments, for example, such decorative structure must be removed before any dry cleaning or washing. Additionally, with frequent cleaning and wear, these decorative accessories will eventually detach from the respective object and, in many cases, fall off the object entirely, leaving behind damage to support material of the object (e.g., holes in clothing). While existing attachment methods are commonly utilized in a wide variety of industries, such attachment methods do not enable decorative accessories to easily maintain three-dimensional configurations since these existing attachment methods often require these decorative accessories to be disposed in a flat configuration when secured to the object.

### SUMMARY

According to aspects, the present disclosure is directed to a mounting system for securing a decorative structure onto an object. The mounting system includes a linkage assembly and a holder. The linkage assembly defines at least one opening and is configured to mount onto the object. The holder is received within the at least one opening of the linkage assembly. The holder defines a central passage and has a first end portion and a second end portion. At least one of the first end portion or the second end portion defines a first slot that is disposed in communication with the central passage. The first slot and the central passage are configured to receive a portion of the decorative structure to secure the decorative structure to the holder and the linkage assembly when the linkage assembly is mounted onto the object.

In aspects, the linkage assembly may include at least one ring that defines the at least one opening. The at least one ring may include a plurality of rings. At least two rings of the plurality of rings may be spaced apart. At least two rings of the plurality of rings may be connected by at least one link that extends between the at least two rings.

In aspects, the at least one ring may have a non-circular configuration.

In aspects, the holder may include a second slot. The first slot may be defined through the first end portion of the holder, and the second slot may be defined through the second end portion of the holder. The first end portion may be a female portion of the holder, and the second end portion may be a male portion of the holder. The male portion may be receivable within the female portion to form the holder.

In aspects, the first slot may have a Y-shaped configuration. The first slot and the second slot may have a Y-shaped configuration.

According to one aspect, this disclosure is directed to a flower mounting system for securing a flower onto an object. The mounting system includes an assembly and a first stem holder. The assembly is configured to be secured to the object. The first stem holder is coupled to the assembly. The first stem holder defines a first slot through a first end face of the first stem holder. The first slot is configured to receive a stem of the flower to secure the flower to the first stem holder and to the assembly when the assembly is coupled to the object. The first slot has a Y-shaped configuration.

In aspects, the assembly may include a first ring that defines a first opening configured to receive the first stem holder. The assembly may include a second ring that defines a second opening configured to receive the first stem holder. The first and second rings may be connected by a link that extends between the first and second rings. At least one of the first or second rings may have a non-circular configuration.

In aspects, the flower mounting system may further include a second stem holder.

In aspects, the first stem holder may define a second slot that is disposed on an opposite end portion of the first stem holder than the first slot. The first stem holder end may include a female portion and a male portion that is receivable within the female portion to form the first stem holder.

In aspects, the mounting system may further include at least one clip that is configured to secure the assembly and the first stem holder to the object.

According to still another aspect, this disclosure is directed to a method for securing a flower to an object. The method includes securing a stem of the flower to a stem holder, securing the stem holder to a linkage assembly, and mounting the linkage assembly with the stem holder and the flower to the object.

Other aspects, features, and advantages will be apparent from the description, the drawings, and the claims that follow.

### BRIEF DESCRIPTION OF THE DRAWINGS

The accompanying drawings, which are incorporated in and constitute a part of this specification, illustrate aspects of the disclosure and, together with a general description of the disclosure given above, and the detailed description of the aspects given below, explain the principles of the disclosure, wherein:

FIG. 1 is a perspective view of a mounting system in accordance with the principles of this disclosure, the mounting system shown supporting a decorative structure on an arm of an object, the decorative structure and the arm of the object shown in broken lines for clarity;

FIG. 2 is a perspective view, with parts separated, of the mounting system and the decorative structure of FIG. 1;

FIG. 3 is a side, cross-sectional view of the mounting system of FIG. 1 as taken along section line 3-3 shown in FIG. 1 with a portion of the decorative structure shown received within the mounting system;

FIG. 4 is a top perspective view of a holder of the mounting system of FIG. 1;

FIG. 5 is a bottom perspective view of the holder of FIG. 4;

FIG. 6 is a top perspective view of another holder of the mounting system of FIG. 1;

FIG. 7 is a bottom perspective view of the holder of FIG. 6;

FIG. 8 is a perspective view, with parts separated, of the holder of FIGS. 6 and 7;

FIGS. 9 and 10 are perspective progressive illustrations of the holder of FIGS. 4 and 5 connecting ends of linkage assemblies of another mounting system;

FIG. 11 is a perspective view, with parts separated, of still another mounting system in accordance with the principles of this disclosure, this mounting system including a pair of linkage assemblies and a pair of holders;

FIG. 12 is a perspective view of yet another mounting system in accordance with the principles of this disclosure, this mounting system including a plurality of linkage assemblies and a plurality of holders connected to support a plurality of decorative structures, the plurality of decorative structures shown in broken lines for clarity;

FIG. 13 is a perspective view of still another mounting system supporting a plurality of decorative structures in accordance with the principles of this disclosure;

FIG. 14 is a perspective view of yet another mounting system supporting a plurality of decorative structures in accordance with the principles of this disclosure;

FIG. 15 is a perspective view, with parts separated, illustrating a portion of another mounting system in accordance with the principles of this disclosure, this view illustrating another holder being received in a complementary connector of another linkage assembly;

FIG. 16 is a perspective view, with parts separated, of the stem holder of FIG. 15;

FIG. 17 is a perspective view of an object including another holder in accordance with the principles of this disclosure;

FIGS. 18 and 19 are perspective views, with parts separated, of various mounting systems in accordance with the principles of this disclosure;

FIG. 20 is a perspective view, with parts separated, of a post assembly for a mounting system in accordance with the principles of this disclosure;

FIG. 21 is perspective view of another post assembly for another mounting system in accordance with the principles of this disclosure;

FIG. 22 is a perspective view of another object including a plurality of holders in accordance with the principles of this disclosure;

FIG. 23 is a perspective view, with parts separated, of still another object shown being coupled to a linkage assembly via a holder in accordance with the principles of this disclosure;

FIG. 24 is a perspective view of another object supporting a holder and coupled to different decorative structures, the decorative structures shown in broken lines for clarity;

FIG. 25 is a perspective view, with parts separated, of yet another mounting system in accordance with the principles of this disclosure;

FIG. 26 is a perspective view of still another mounting system in accordance with the principles of this disclosure;

FIG. 27 is a perspective view of yet another mounting system in accordance with the principles of this disclosure;

FIG. 28 is a perspective view illustrating the mounting system of FIG. 27 securing a decorative structure to a ponytail, the decorative structure and the ponytail shown in broken lines for clarity;

FIGS. 29-34 are perspective views of various mounting systems that support decorative structures to various footwear in accordance with the principles of this disclosure, the decorative structures and various footwear shown in broken lines for clarity;

FIGS. 35 and 36 are progressive views illustrating yet another mounting system securing decorative structures to a visor in accordance with the principles of this disclosure; and

FIGS. 37 and 38 are progressive views illustrating still another mounting system securing decorative structures to hair of a head in accordance with the principles of this disclosure, the decorative structures and the head, including the hair, shown in broken lines for clarity.

### DETAILED DESCRIPTION

The disclosed apparatus will now be described in detail with reference to the drawings, in which like reference numerals designate identical or corresponding elements in each of the several views. However, it is to be understood that aspects of the disclosure are merely exemplary of the disclosure and may be embodied in various forms. Well-known functions or constructions are not described in detail to avoid obscuring the disclosure in unnecessary detail. Therefore, specific structural and functional details disclosed herein are not to be interpreted as limiting, but merely as a basis for the claims and as a representative basis for teaching one skilled in the art to variously employ the disclosure in virtually any appropriately detailed structure. In addition, directional terms such as upper, lower, and similar terms are used to assist in understanding the description and are not intended to limit the disclosure.

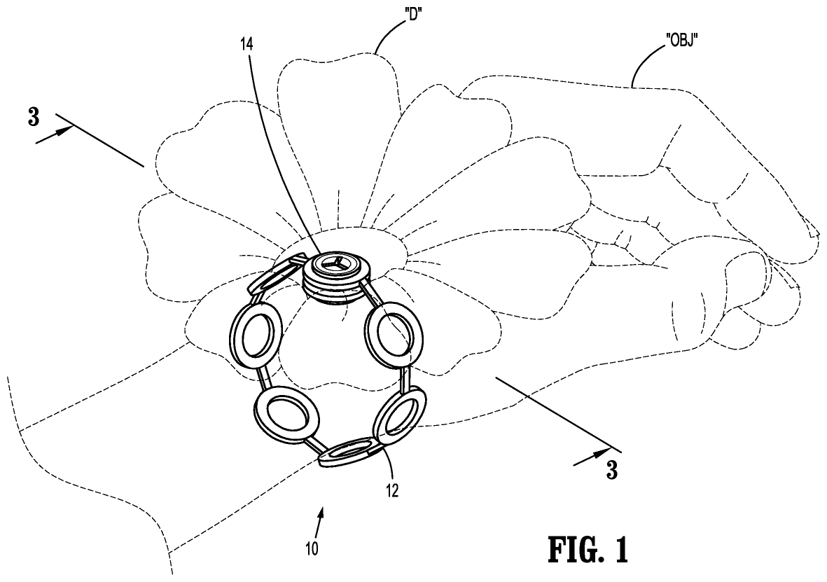

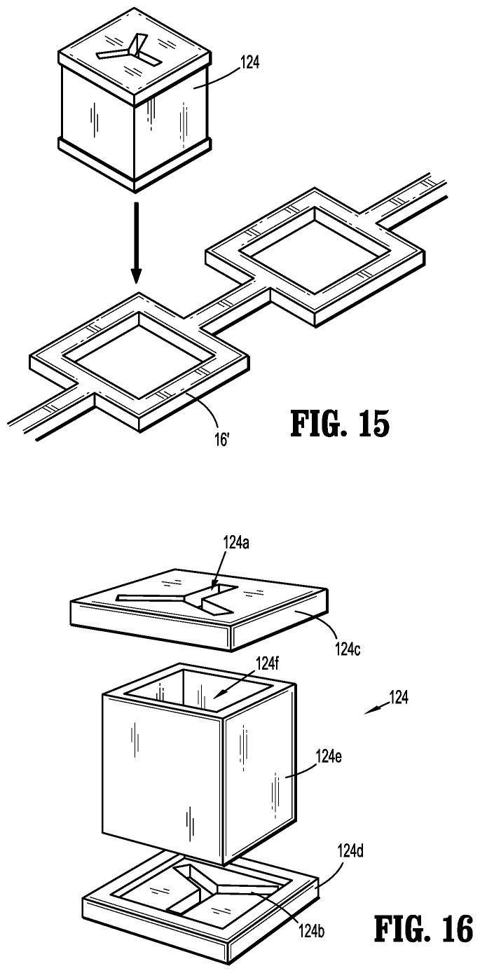

Referring initially to FIGS. 1-3, a mounting system 10 includes a linkage assembly 12 and a holder 14 that couples to the linkage assembly 12 for securing a decorative structure “D”, such as flower “F” having a stem “S”, to an object “OBJ” (e.g., an arm of a user or mannequin) when the decorative structure “D” is coupled to the holder 14 and the mounting system 10 is coupled to the object “OBJ”. The linkage assembly 12 includes one or more rings 16 that are connected, and may be spaced-apart by, one or more links 18, which may have any suitable shape and/or configuration (e.g., rod, tube, spiral, ball, chain, link, letter, word, phrase, number, character, design, etc.). Further, although each link 18 is shown as a single link, each link 18 may be multiple links connected (see e.g., link assembly 102 in FIG. 13) and/or spaced apart relative to one another (e.g., extending in parallel and/or transverse to one another, coaxial with, and/or at least partially rotated about, and/or interwoven with one another, or the like). In aspects, two or more of the rings 16 may be directly and/or indirectly connected to one another with or without links 18. Further, although rings 16 are shown as having a circular configuration, rings 16 may have any circular or non-circular configuration (e.g., square: see ring 16′ shown in FIG. 15, triangle, elliptical, c-shaped, etc.). In aspects, although each individual ring 16 is shown as a singular ring, one or more of such individual rings may be provided as one or more connected parallel rings (e.g., a double-ring, triple-ring, etc.) and/or in the form of one or more spirals or the like. Indeed, linkage assembly 12, or components thereof, may be formed of any suitable flexible and/or non-flexible material (e.g., polymeric, wood, metallic, ceramic, fabric, filaments, etc.) and/or may have any number of any suitable layers, coatings, textures, decorative indicia or the like thereon.

Each ring 16 of the linkage assembly 12 defines an opening 16x therethrough that is configured to receive the holder 14 for coupling the holder 14 to the linkage assembly 12. The linkage assembly 12 may be provided in the form of a bracelet. The linkage assembly 12 includes a first end ring 16a on a first end of the linkage assembly 12 and a second end ring 16b on a second end of the linkage assembly 12. The linkage assembly 12 may further include one or more intermediate rings 16c disposed between the first and second end rings 16b, and which may be separated by one or more links 18.

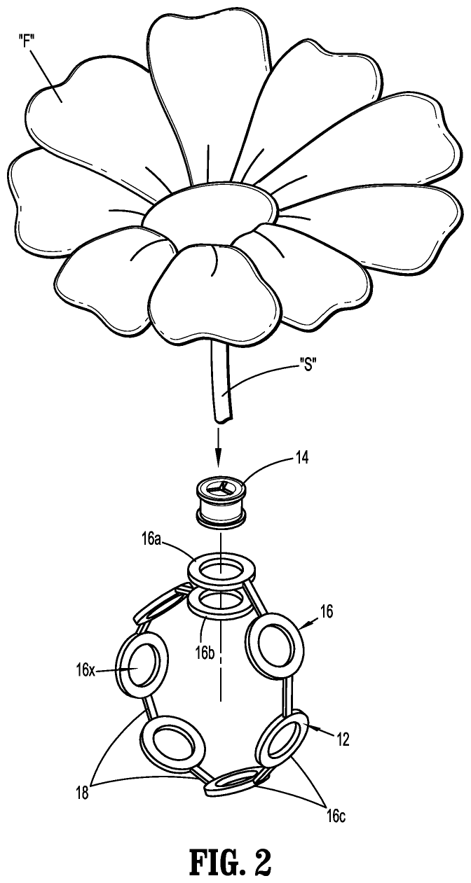

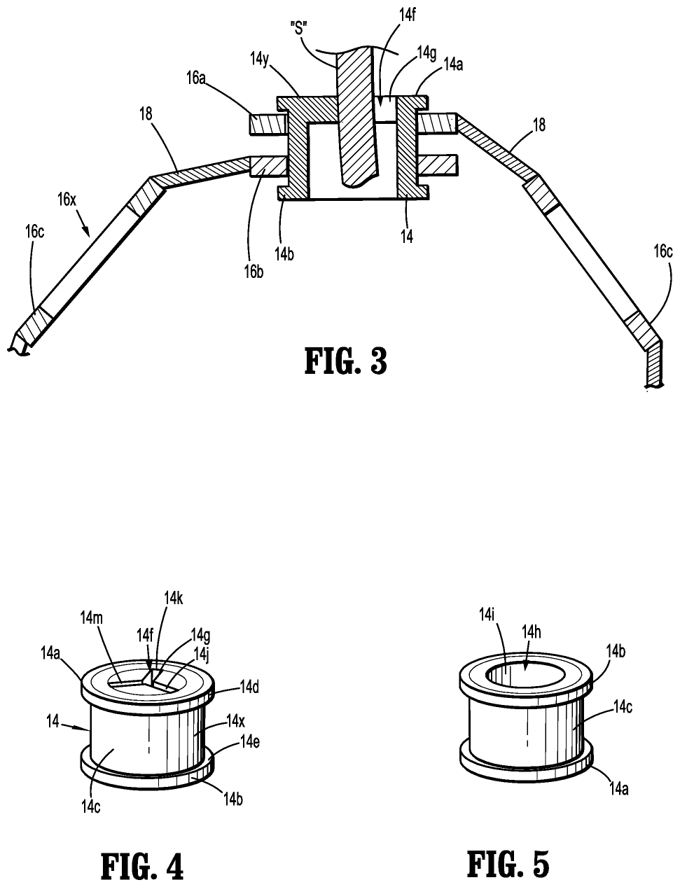

The holder 14, which may be in the form of a stem holder, secures the stem “S” of a flower or other similar structure to the holder 14. As seen in FIGS. 4 and 5, holder 14 can be in the form of a one-sided holder. The holder 14 includes a tubular body 14a, which may be cylindrical. The tubular body 14x includes a first plate 14a on a first end of the tubular body 14x and a second plate 14b on a second end of the tubular body 14x. The first and second plates 14a, 14b extend radially outward of an outer surface 14c of the tubular body 14x to define a first ledge 14d and a second ledge 14e, respectively. The first plate 14a includes an inner surface 14g that defines a slot 14f through an end face 14y of the holder 14 for receiving the stem “S” in a central passage 14h defined by an inner surface 14i of the tubular body 14x that is disposed in fluid communication with the slot 14f. The inner surface 14g of the first plate 14a is configured to frictionally engage the stem “S” when the stem “S” is inserted into the slot 14f for securing the flower “F” to the holder 14 (see FIGS. 2 and 3). The stem “S” can be advanced through the slot 14f into the central passage 14h defined of the tubular body 14a. The slot 14f, which is shown as Y-shaped, may have any suitable shape or configuration (e.g., a star), with any number or arrangement of segments. For instance, the Y-shape has three segments, a first segment 14j, a second segment 14k, and a third segment 14m.

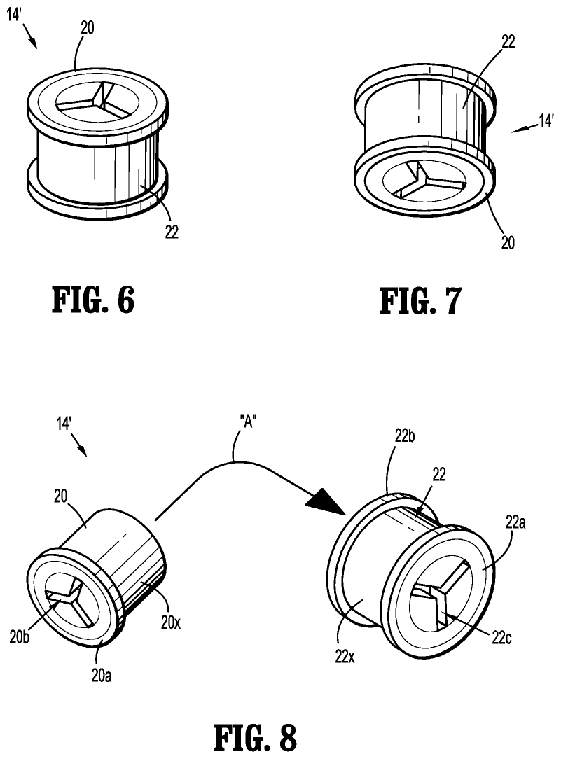

As seen in FIGS. 6-8, the holder can be in the form a two-sided holder, which may be a unitary piece having slots 14f on opposite ends thereof. In some aspects, a two-sided holder 14′ may have a male portion 20 and a female portion 22 that couple together such that the male portion 20 is received within the female portion 22, as indicated by arrow “A”. The male portion 20 includes a tubular body 20x having a first plate 20a on a first end that defines a slot 20b through an end face of the first plate 20a of the male portion 20. A second end of the tubular body 20x does not include a plate. The female portion 22 includes a tubular body 22x having a first plate 22a on a first end of the tubular body 22x, and a second plate 22b on a second end of the tubular body 22x. The first plate 22a defines a slot 22c through an end face of the first plate 22a of the female portion 22. When the male portion 20 is received within the female portion 22, the first plate 20a of the male portion 20 is supported on the second end of the female portion 22 opposite to the first plate 22a of the female portion 22. In this regard, a decorative object can be coupled to either side of the two-sided holder 14′, namely, via the slot 22c of the first plate 22a of the female portion 22 or via the slot 20b of the first plate 20a of the male portion 20.

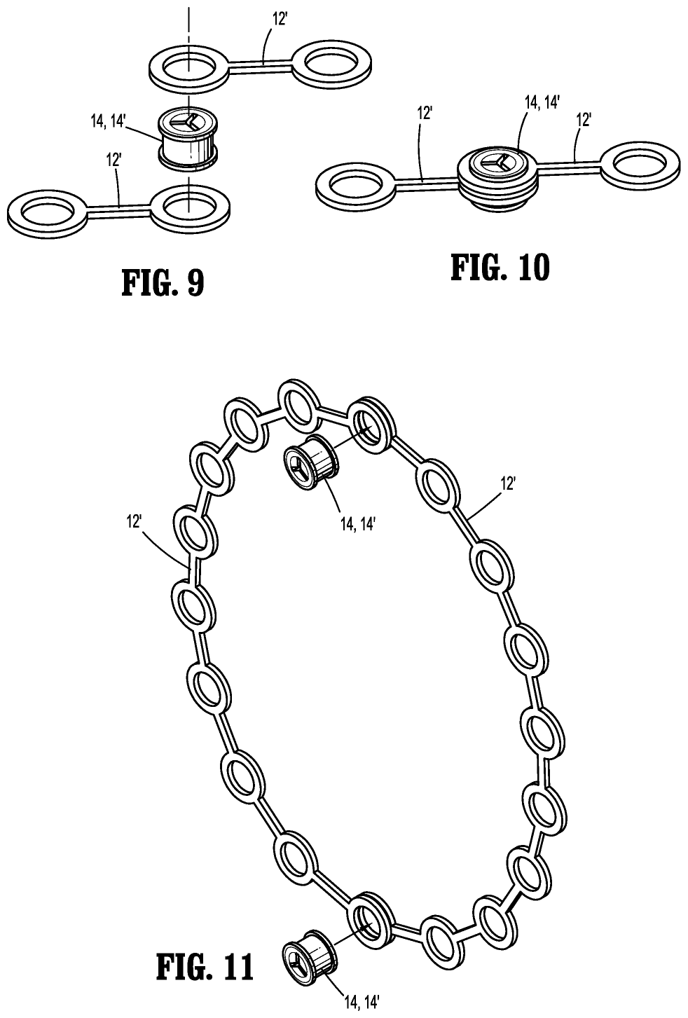

Turning now to FIGS. 9-11, to connect different linkage assemblies together or different ends of a link assembly together, the holder, such as one of holders 14 and 14′, is inserted into a pair of rings 16, such as 16a, 16b (as seen in FIG. 3) so that the pair of rings 16 are supported on the outer surface 14c of the tubular body 14x of the holder 14, 14′ and between the first and second plates 14a, 14b (or between the first plate 22a of the female portion 22 and the first plate 20a of the male portion 20) to maintain the respective pair of rings 16 in parallel alignment with one another for coupling the opposite ends of the linkage assembly 12 together to define a mounting system for coupling a decorative structure to an object (or for coupling a different linkage assemblies, such as a pair of linkage assemblies 12′, 12′ or 12″, 12″ together to form a necklace or bracelet that can be coupled to an object such as a person or mannequin).

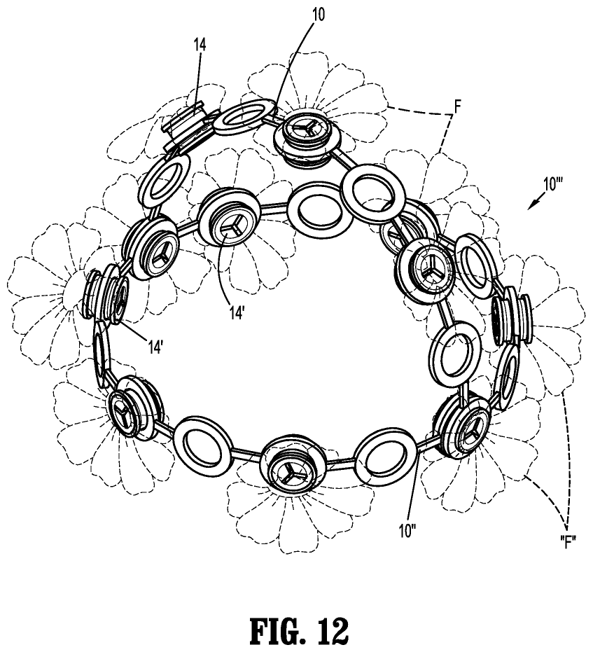

As seen in FIG. 12, multiple mounting systems 10′, 10″ can be coupled together to form more complex mounting systems such as mounting system 10′″, and each ring 16 of each linkage assembly of the respective mounting systems can receive one of the holders 14, 14′ to enable decorative structures, such as flowers “F”, to be secured to each of the respective holders 14, 14′ of the mounting system 10′″ to form, for example, a hair bun cover.

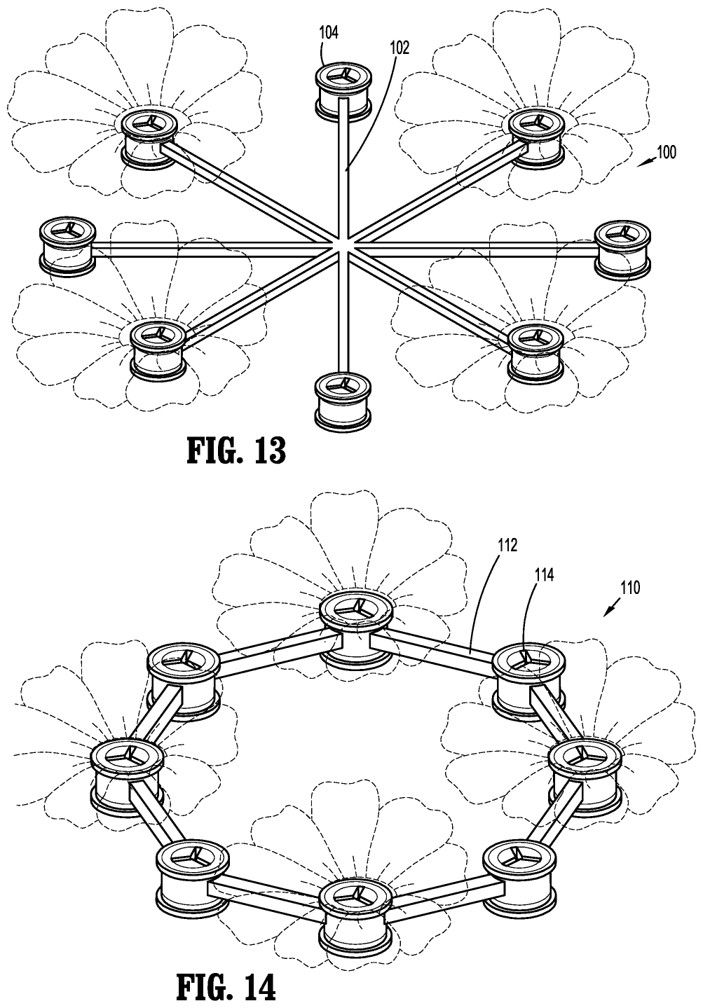

With reference to FIGS. 13 and 14, some mounting systems 100, 110 can include one or more holders 104, 114 that are integrally formed with one or more linkage assemblies 102, 112.

As seen in FIG. 15, the disclosed holders, like rings, can be provided in any suitable shape and/or configuration such as circular and/or non-circular configurations for complementing a corresponding ring such as square-shaped ring 16′. For example, holder 124 can have a rectangular configuration. FIG. 16 illustrates that holder 124 can also be two-sided (or one-sided, tri-sided, quad-sided, etc.). In other words, holder 124 can have a first slot 124a defined on a first end of the holder 124 and a second slot 124b defined on a second end of the holder 124 opposite to the first end. The first and/or second slots 124a, 124b can be formed in caps 124c, 124d that connect to opposite ends of a holder body 124e using any suitable technique such as friction fit, snap-on, magnets, pins, fasteners, hook-and-loop, etc, or combinations thereof. In aspects, such caps can include one or more arms (not explicitly shown) that are receivable (e.g., friction-fit) into openings 125f defined through the holder body 124e.

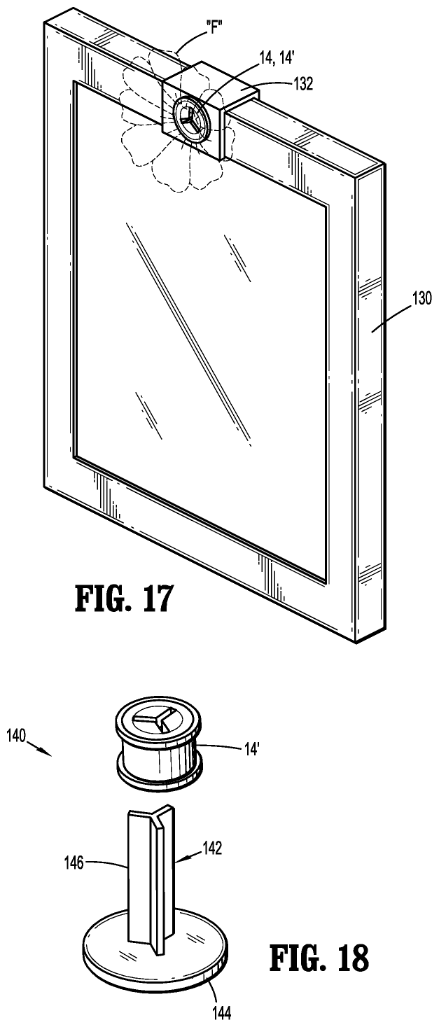

With reference to FIG. 17, one of the disclosed holders, such as holders 14, 14′, 124 can be secured to an object 130, such as a frame, for supporting a decorative structure such as a flower “F”. For instance, one linkage assembly can be provided in the form of a frame clip 132.

As seen in FIG. 18, one mounting system 140 includes one of the two-sided holders 14′, 124, for example, and a support assembly 14 that can be coupled to the two-sided holder, for example, to attach the holder to a hair braid. The support assembly 142 includes a base plate 144 and a connector arm 146 that extends in a normal (perpendicular) direction from the base plate 144. The connector arm 146 may have a Y-shaped profile that can be received in the complementary Y-shaped profile of one of the slots of the two-sided holder so that the other slot can receive, for example, the stem “S” of the flower “F”.

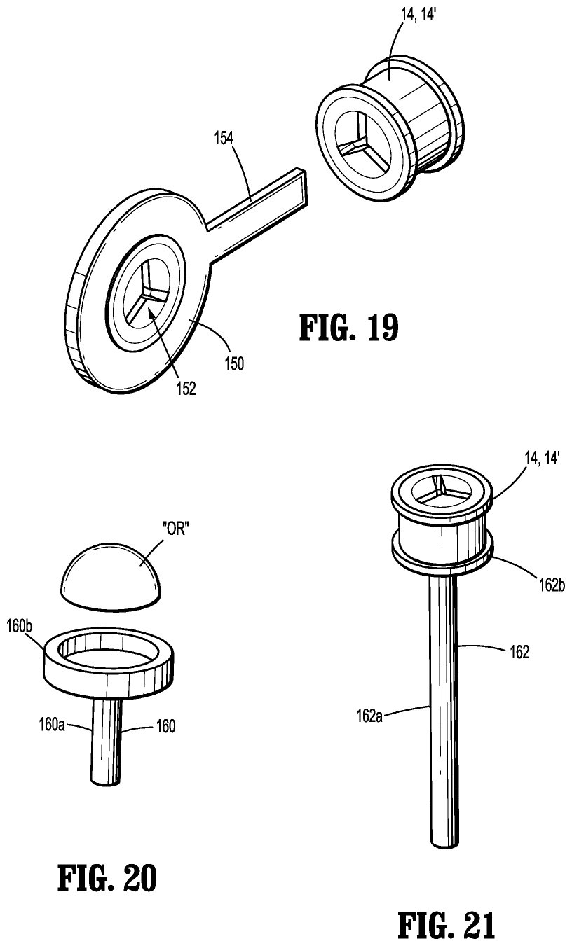

With reference to FIG. 19, a perpendicular holder 150 can be connected to one of the holders 14, 14′, 124 so that when they are collectively connected to a linkage assembly, such as linkage assembly 12, a decorative structure such as a stem of a flower may be inserted into a slot 152 defined by perpendicular holder 150. The perpendicular holder 150 further includes a tab 154 that extends from the perpendicular holder 150 for receipt in one or more of the different segments (e.g., segments 14j, 14k, and 14m). In this regard, the flower may protrude from the object at a desired orientation and/or angle.

Referring to FIGS. 20 and 21, post assemblies 160, 162 may be provided upon which one or more of the holders 14, 14′, 124 can be mounted for supporting a decorative structure and/or a linkage assembly, for instance for added structural support. Post assemblies 160, 162 may have posts 160a, 162a with platforms 160b, 162b having any suitable configurations for accommodating, for example, a holder 14, 14′ and/or an ornament “OR”.

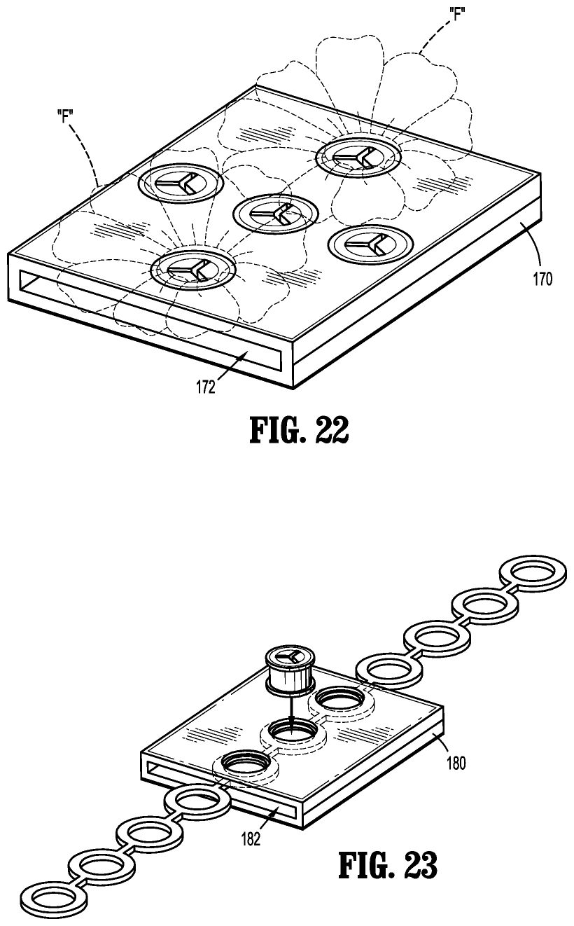

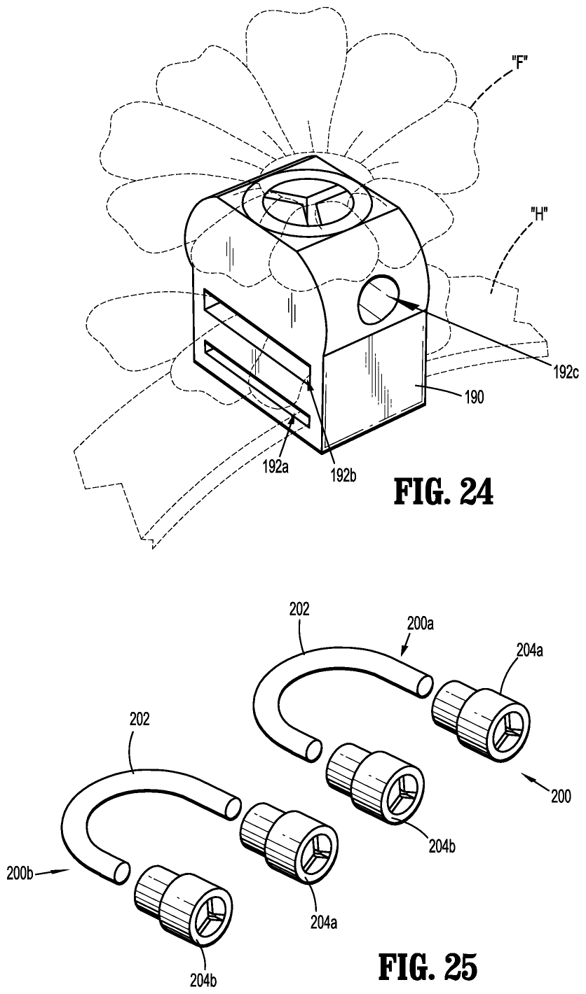

FIGS. 22-24 illustrate various objects, such as objects 170, 180, 190 that permanently or removably support one or more holder and/or linkage assemblies for supporting various decorative structures such as flowers “F”, and which include one or more circular and/or non-circular channels 172, 182, 192a, 192b, 192c for supporting decorative structures such as headbands “H” or other decorative structures.

With reference to FIG. 25, one mounting system 200 can include one or more ear cuff assemblies 200a, 200b. Each ear cuff assembly 200a, 200b includes a cuff 202 and a pair of holders 204a, 204b that couple to the opposite ends of the cuff 202. Cuff 22 can have any suitable shape and/or configuration and be of any suitable dimension. Cuff 22 may be formed of flexible and/or rigid material. Cuff 22 may be wrapped, wound, and/or spiraled to secure to an object and/or to act as a support base for supporting holders 204a, 204b in positions on an object, for example.

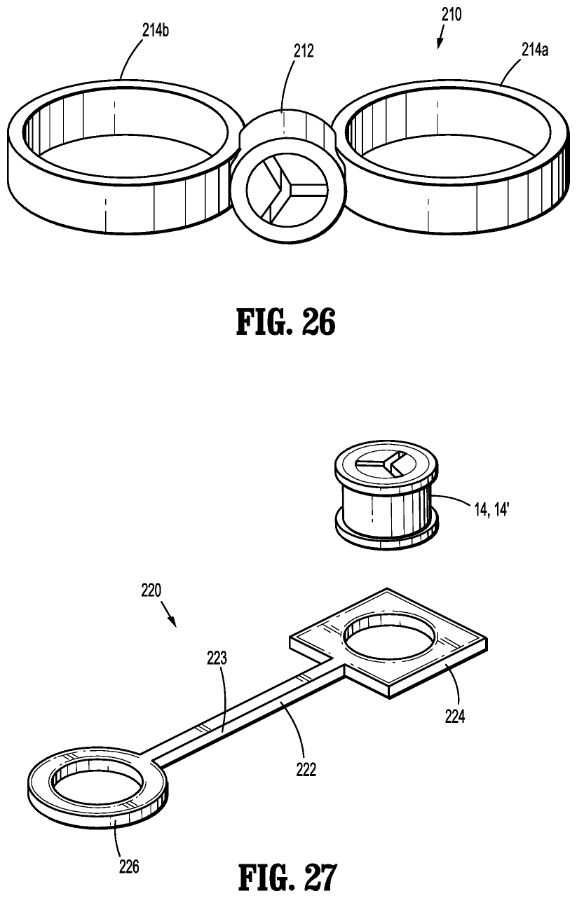

As seen in FIG. 26, another mounting system 210 includes a holder 212 disposed between and integrally formed with a pair of annular members 214a, 214b. The holder 212 may be oriented transverse (e.g., 90 degrees offset from) openings defined through the pair of annular members 214a, 214b.

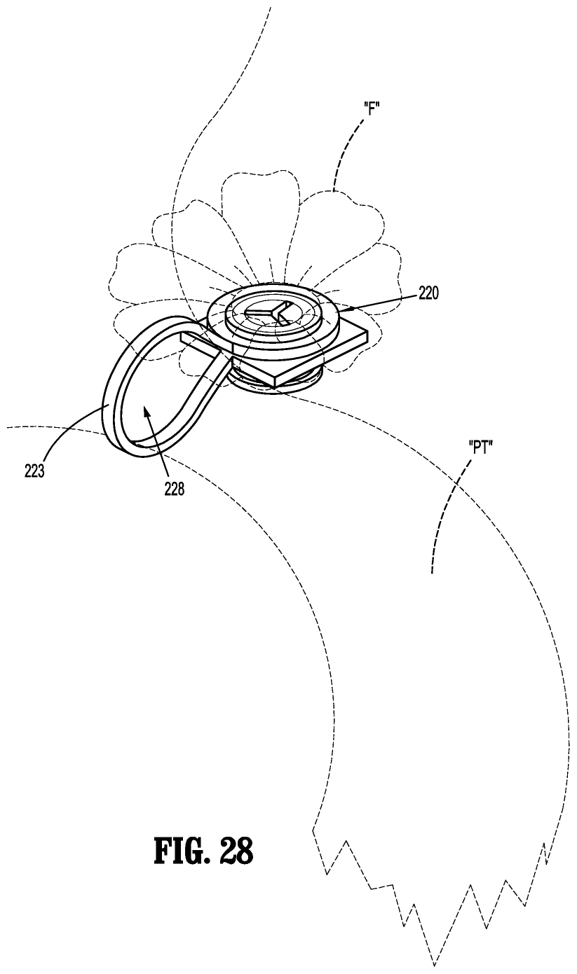

Turning now to FIGS. 27 and 28, still another mounting system 220 includes a holder 14, 14′ and a linkage assembly 222 having a first ring 224 on a first end and a second ring 226 on a second end of the linkage assembly 222. The first and second rings 224, 226 are shown with different configurations. As seen in FIG. 28, the linkage assembly 222 can be folded over to align first and second rings 224, 226 for coupling the rings 224, 226 together with the holder 14, 14′ and forming a passage 228 through a flexible arm 223 of the linkage assembly 222 through which a ponytail “PT” can be captured, for example. As in other aspects, the holder 14, 14′ can secure a decorative structure such as a flower “F” thereto.

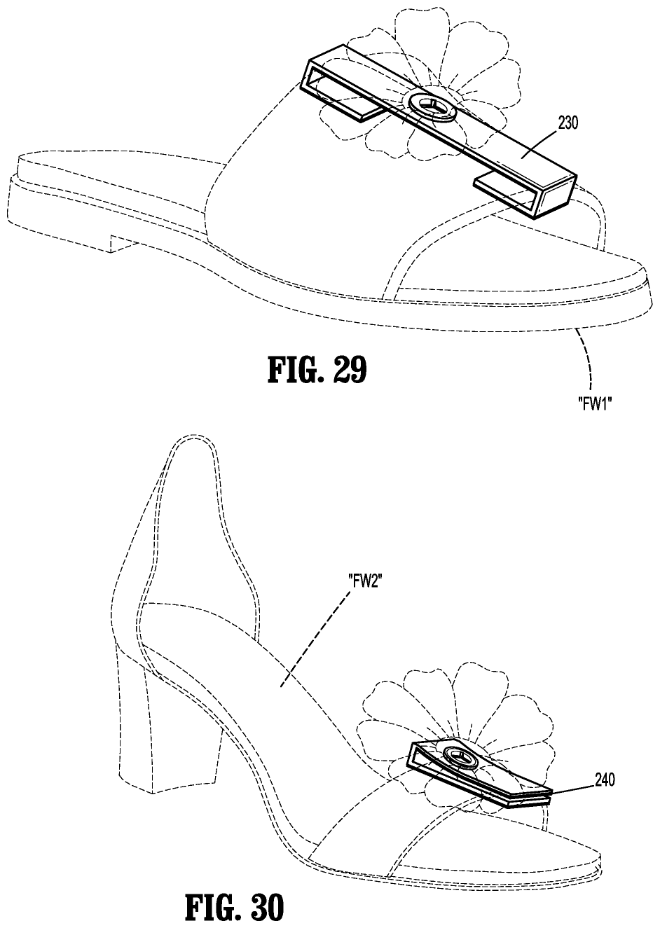

As seen in FIGS. 29 and 30, one or more holders, such as holders 14, 14′, can be incorporated into and/or selectively attachable to linkage assemblies in the form of footwear clips, such as footwear clips 230, 240, for supporting decorative structures like flowers “F” onto footwear “FW1” or “FW2”.

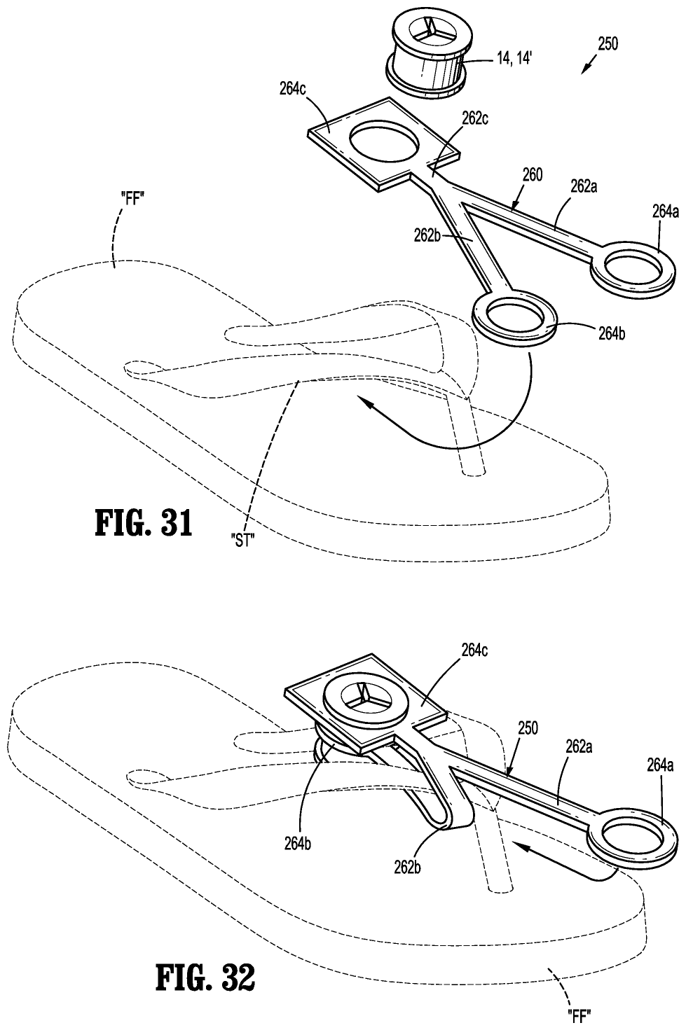

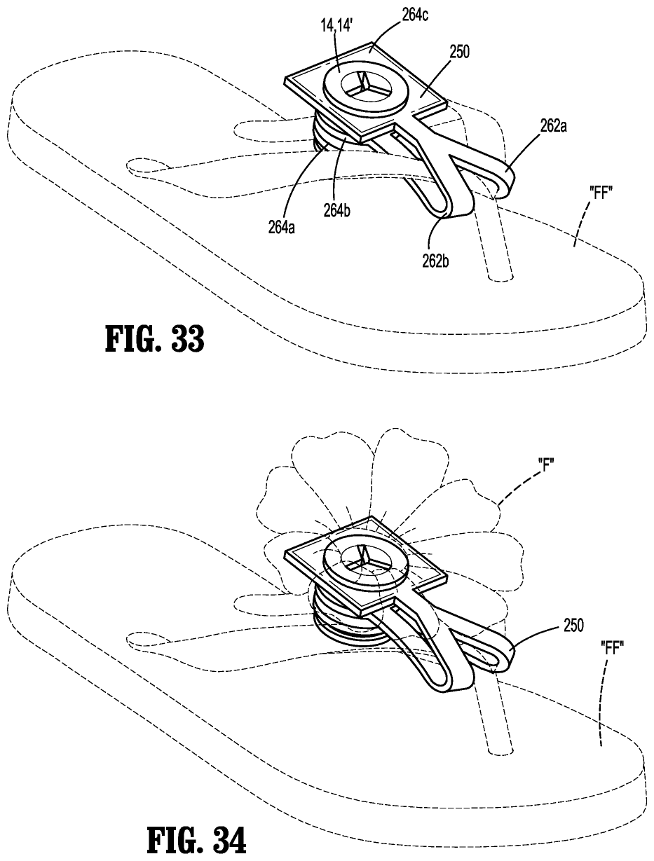

With reference to FIGS. 31-34, another mounting system 250 includes a holder, such as one of the holders 14 or 14′, and another footwear clip 260. Footwear clip 260 includes flexible links 262a, 262b, 262c that connect at one end thereof. Each of the links 262a to 262c supports a ring at a second end thereof. For instance, the link 262a supports a ring 264a, the link 262b supports a ring 264b, and the link 262c supports a ring 264c. Such mounting system 250 can be used to secure a decorative structure, such as a flower “F”, to straps “ST” of a flip-flop “FF” by folding the links 262a and 262b around the straps “ST” and coupling as the rings 264a to 264c together with the holder 14, 14′ so that the mounting system 250 can secure the flower “F” to the flip-flop “FF” via the holder 14, 14′.

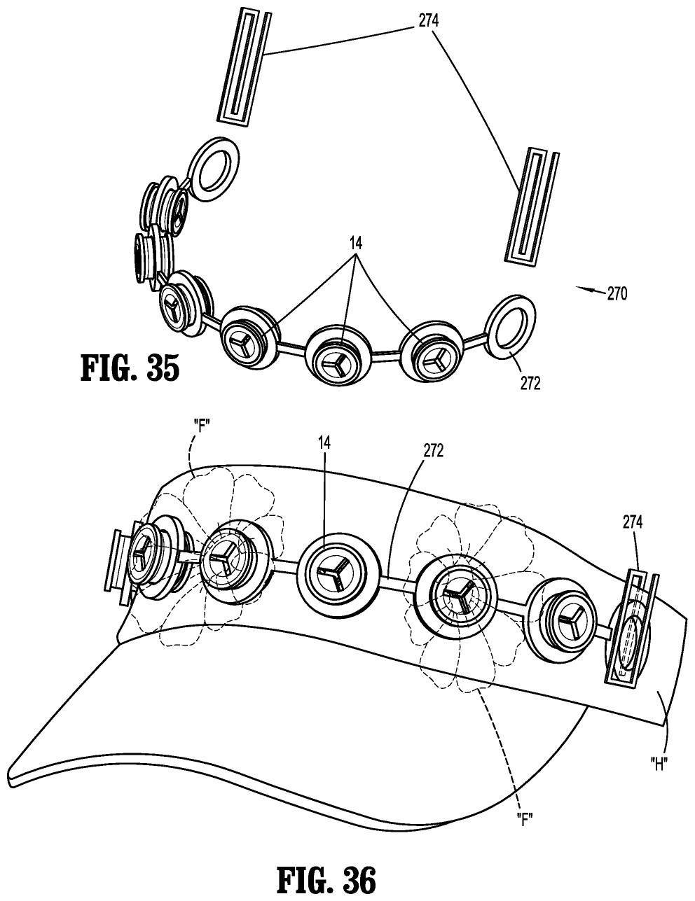

As seen in FIGS. 35 and 36, yet another mounting system 270 includes a linkage assembly 272 and a plurality of holders 14 that are coupled to the linkage assembly 272. The mounting system 270 further includes a plurality of clips 274 that can be used to secure the linkage assembly 272 and the plurality of holders 14 to an object such as a hat or visor “H” so that the holders 14 can secure one or more decorative structures such as flowers “F” to the hat or visor “H”.

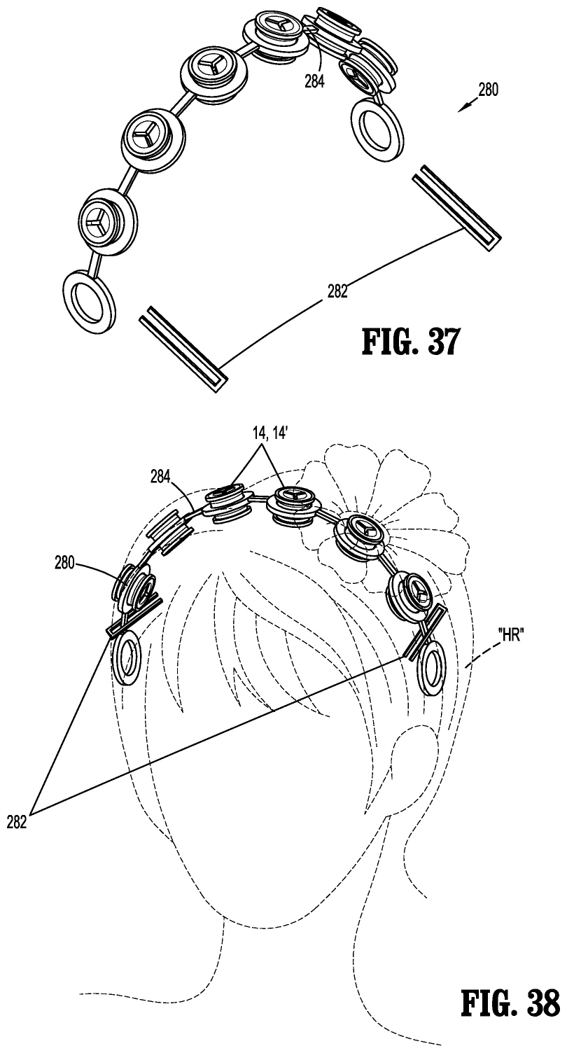

With reference to FIGS. 37 and 38, like mounting system 270, a mounting system 280 can include clips 282 that facilitate securement of a linkage assembly 284 and a plurality of holders 14, 14′ to an object such as hair “HR” of a user or mannequin.

In aspects, the disclosed mounting systems, or components thereof, are configured to be interchangeable with, permanently or temporarily attached to, or removable from one or more other mounting systems, or components thereof, which may have the same or different configuration. Additionally, the linkage assembly 12 and/or holder 14 may be made by any suitable manufacturing technique such as molding (e.g., injection molding), printing (e.g., 3D printing), milling, stamping, rolling, welding, laser cutting, or the like.

In aspects, the disclosed mounting systems, or components thereof, can be utilized to create three-dimensional ornamental items (e.g., jewelry and accessories) that are decorative in themselves.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications may be effected by one skilled in the art without departing from the scope or spirit of the disclosure. Additionally, the elements and features shown or described in connection with certain aspects may be combined with the elements and features of certain other aspects without departing from the scope of the present disclosure, and that such modifications and variations are also included within the scope of this disclosure. Accordingly, the subject matter of this disclosure is not limited by what has been particularly shown and described.

What is claimed is:

1. A mounting system for securing a decorative structure onto an object, the mounting system comprising:
a linkage assembly defining at least one opening and configured to mount onto the object; and
a holder received within the at least one opening of the linkage assembly, the holder defining a central passage and having a first end portion and a second end portion, wherein at least one of the first end portion or the second end portion defines a first slot that is disposed in communication with the central passage, the first slot and the central passage configured to receive a portion of the decorative structure to secure the decorative structure to the holder and the linkage assembly when the linkage assembly is mounted onto the object.

2. The mounting system of claim 1, wherein the linkage assembly includes at least one ring that defines the at least one opening.

3. The mounting system of claim 2, wherein the at least one ring includes a plurality of rings.

4. The mounting system of claim 3, wherein at least two rings of the plurality of rings are spaced apart.

5. The mounting system of claim 3, wherein at least two rings of the plurality of rings are connected by at least one link that extends between the at least two rings.

6. The mounting system of claim 2, wherein the at least one ring has a non-circular configuration.

7. The mounting system of claim 1, wherein the holder includes a second slot, and wherein the first slot is defined through the first end portion of the holder, and the second slot is defined through the second end portion of the holder.

8. The mounting system of claim 7, wherein the first end portion is a female portion of the holder, and the second end portion is a male portion of the holder, and wherein the male portion is receivable within the female portion to form the holder.

9. The mounting system of claim 1, wherein the first slot has a Y-shaped configuration.

10. The mounting system of claim 7, wherein the first slot and the second slot have a Y-shaped configuration.

11. A flower mounting system for securing a flower onto an object, the mounting system comprising:
an assembly configured to be secured to the object; and
a first stem holder coupled to the assembly, the first stem holder defining a first slot through a first end face of the first stem holder, the first slot configured to receive a stem of the flower to secure the flower to the first stem holder and to the assembly when the assembly is coupled to the object, the first slot having a Y-shaped configuration.

12. The flower mounting system of claim 11, wherein the assembly includes a first ring that defines a first opening configured to receive the first stem holder.

13. The flower mounting system of claim 12, wherein the assembly includes a second ring that defines a second opening configured to receive the first stem holder.

14. The flower mounting system of claim 11, further comprising a second stem holder.

15. The flower mounting system of claim 13, wherein the first and second rings are connected by a link that extends between the first and second rings.

16. The flower mounting system of claim 13, wherein at least one of the first or second rings has a non-circular configuration.

17. The flower mounting system of claim 11, wherein the first stem holder defines a second slot that is disposed on an opposite end portion of the first stem holder than the first slot.

18. The flower mounting system of claim 17, wherein the first stem holder end includes a female portion and a male portion that is receivable within the female portion to form the first stem holder.

19. The mounting system of claim 11, further comprising at least one clip that is configured to secure the assembly and the first stem holder to the object.

20. A method for securing a flower to an object, the method comprising:
securing a stem of the flower to a stem holder;
securing the stem holder to a linkage assembly; and
mounting the linkage assembly with the stem holder and the flower to the object.
